(19) United States
(12) Patent Application Publication
(10) Pub. No.: US 2015/0242834 A1
(43) Pub. Date: Aug. 27, 2015

(54) SPLIT PAYMENT ENGINE AND METHOD TO FACILITATE ELECTRONIC TRANSACTION AGGREGATION

(71) Applicants: Steve David Goldsmith, Austin, TX (US); James Aron Vaughan, Austin, TX (US)

(72) Inventors: Steve David Goldsmith, Austin, TX (US); James Aron Vaughan, Austin, TX (US)

(73) Assignee: Homeaway.com, Inc., Austin, TX (US)

(21) Appl. No.: 14/186,723

(22) Filed: Feb. 21, 2014

(51) Int. Cl. G06Q 20/22

(52) U.S. Cl. CPC G06Q 20/22

(57) ABSTRACT

Various embodiments relate generally to computer software, network communications and networked applications, and computing devices, including wired and wireless mobile and computing devices, for interfacing with a payment processor that provides electronic payments as a service, and more specifically, to a split payment engine and method for fulfillment of goods and services, such as reserving a rental property and ancillary goods and services, via, for example, aggregation of electronic transactions. In some embodiments, a method includes receiving a request acquire multiple goods or services from different good or service providers, and initiating a split payment operation at a processor to apply against an account. The split payment operation includes determining that the split payment operation is associated with either a first or a second state, and causing, if the request is in the first state, payments collectively represented as a single transaction in association with the account.

### CROSS-REFERENCE TO RELATED APPLICATIONS

This application is co-related to U.S. Nonprovisional patent application Ser. No. 1x/xxx,xxx, filed Feb. 21, 2014 with Attorney Docket No. HOM-102, and entitled “CORRELATING TRANSACTIONS FOR AN AGGREGATED ELECTRONIC TRANSACTION IN ASSOCIATION WITH SPLIT PAYMENT OPERATIONS,” which is herein incorporated by reference in its entirety and for all purposes.

### FIELD

The various embodiments of the invention relate generally to electrical and electronic communications, computer software, network communications and networked applications, and computing devices, including wired and wireless mobile and computing devices, for interfacing with a payment processor that provides electronic payments as a service, and more specifically, to a split payment engine and method for fulfillment of goods and services, such as reserving a rental property and ancillary goods and services, via, for example, aggregation of electronic transactions.

### BACKGROUND

Some online sellers provide an electronic marketplace using the Internet in which the operator of the marketplace promotes and offers for sale products originating from multiple third party providers. The operator of an online marketplace typically is a “merchant of record,” whereby the online marketplace operator assumes responsibility to process payment transactions of various financial instruments, including credit cards. Such an operator also communicates the purchase requests of multiple items to multiple third party providers, such as wholesalers and retailers, to fulfill the order of the purchased items. Therefore, the marketplace operator bills the purchaser and then pays the multiple third party providers.

While functional, the conventional techniques for fulfilling an order of online purchases are suboptimal. To illustrate, consider that an operator of an online marketplace usually offers an online “shopping cart” in which multiple goods and services are selected by a purchaser using a purchasing computer device via a network. The marketplace operator collects the funds to fulfill the purchase from the buyer, calculates separate amounts owed to each of the different third party providers, and remits a payment by way of a transaction via a network to each seller. Further, consider that one or more of the third party providers are unable to provide their ordered products or services to fulfill the order, whereas one or more other third party provides can provide the ordered products or services. For example, an ordered item may not be available if a third party provider does not have the item in inventory, or if the purchaser has insufficient funds to complete the series of transactions. The marketplace operator then fulfills only part of the order until a later time. The inability to fulfill the entire order, as well as a variety of other deficiencies, frequently gives rise to frustration and dissatisfaction with the online marketplace operator. Further, the series of transactions are billed, such as on credit card statements, separately and at different times (e.g., over multiple statement periods). Thus, the one or more ordered items cannot be fulfilled coincidently, thereby increasing the burden of tracking fulfillment of each ordered item. Another drawback of providing some conventional online marketplaces is that the operator—as the merchant-of-record—is liable for payments to the third party providers, including losses due to fraud and other financial anomalies, such as charge-back risks (e.g., risks of a mandatory return of funds to the purchaser to settle a disputed charge). Yet another drawback of traditional online marketplaces is that legal, foreign, and/or technical boundaries or requirements typically discourage the purchasers and/or operators of online marketplaces from offering goods or services that cross such boundaries.

Thus, what is needed is a solution for overcoming the disadvantages of conventional devices and techniques for processing electronic transactions, including payment transactions, to fulfill and correlate online orders of goods and services offered by multiple provider entities.

### BRIEF DESCRIPTION OF THE DRAWINGS

Various embodiments or examples (“examples”) are disclosed in the following detailed description and the accompanying drawings:

FIG. 1 illustrates an example of a system that includes a split payment engine to cooperate with a payment processor, which provides online electronic payments as a service, for the fulfillment of goods and services, according to some embodiments;

FIG. 2A illustrates an example of a system that includes a split payment engine to cooperate with a payment processor for the fulfillment of a principal service of renting property and ancillary goods and services, according to some embodiments;

FIG. 2B is an example of a flow for implementing dynamic data processing, according some embodiments;

FIG. 3 illustrates an aggregated electronic transaction, according to some embodiments;

FIG. 4 illustrates an example of a split payment engine, according to some embodiments;

FIG. 5A is an example of a flow of splitting payments, according to some embodiments;

FIG. 5B is an example of a flow of implementing an escrow data processor for a provider of goods or services, according to some embodiments;

FIGS. 6A and 6B depict a user interface and functional diagram, respectively, of a payment request for multiple goods and services providers, according to some embodiments;

FIGS. 7A and 7B depict a user interface and functional diagram, respectively, of an additional payment request for multiple goods and services providers, according to some embodiments;

FIGS. 8A and 8B depict a user interface and functional diagram, respectively, of reverse payment request (e.g., a refund request) for multiple goods and services providers, according to some embodiments;

FIG. 9 is a diagram depicting a transaction correlator, according to some embodiments;

FIG. 10 is a diagram depicting a payment processor entity receiving a correlation identifier in view of a transaction fee structure, according to some embodiments;

FIGS. 11A and 11B are diagrams depicting use of a correlation identifier, according to some embodiments;

FIG. 12 is an example of a flow of optimizing transactions based on correlation identifiers, according to some embodiments;

FIG. 13 is a functional state diagram depicting states in which a provider aggregator system or a reservation manager correlates transactions, according to various embodiments; and

FIG. 14 illustrates an exemplary computing platform in accordance with various embodiments.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

In some examples, the described techniques may be implemented as a computer program or application (hereafter “applications”) or as a plug-in, module, or sub-component of another application. The described techniques may be implemented as software, hardware, firmware, circuitry, or a combination thereof. If implemented as software, the described techniques may be implemented using various types of programming, development, scripting, or formatting languages, frameworks, syntax, applications, protocols, objects, or techniques, including ASP, ASP.net, .Net framework, Ruby, Ruby on Rails, ReST architectures, C, Objective C, C++, C#, Adobe® Integrated Runtime™ (Adobe® AIR™), ActionScript™, Flex™, Lingo™, Java™, Javascript™, Ajax, Perl, COBOL, Fortran, ADA, XML, MXML, HTML, DHTML, XHTML, HTTP, XMPP, PHP, and others. The described techniques may be varied and are not limited to the embodiments, examples or descriptions provided.

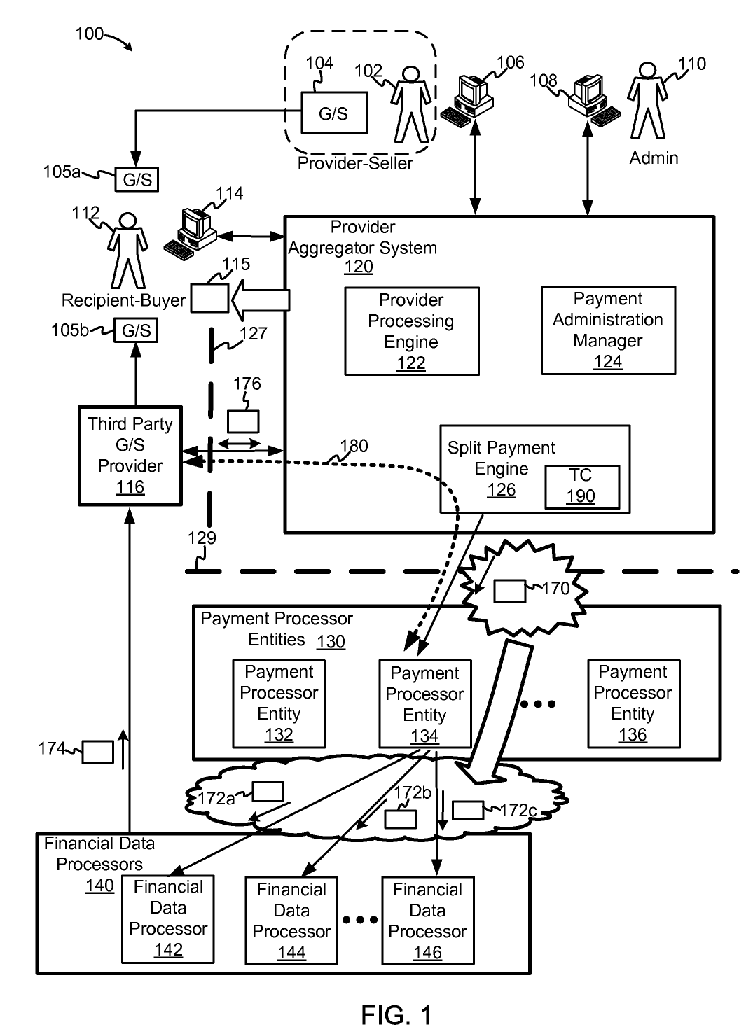

FIG. 1 illustrates an example of a system that includes a split payment engine configured to cooperate with a payment processor, which provides online electronic payments as a service, for the fulfillment of goods and services, according to some embodiments. Diagram 100 depicts a provider aggregator system 120 configured to receive data representing a request from, for example, a user (“recipient-buyer”) 112, from a purchaser computing device 114, to purchase or otherwise acquire one or more goods or services, such as goods or services (“G/S”) 105a and 105b from different good or service providers. As used herein, the term “order” can describe, at least in some embodiments, data representing a request to purchase online one or more goods or services offered for sale or rental online, and can refer to the purchase request generated at computing device 114 to acquire one or more items provided by the goods or services providers. Each of the multiple goods or services has a cost of acquisition (e.g., a price, or in-kind exchange of equivalent value). An account associated with the request from computing device 114 also can be identified, whereby the account is a resource for financing the cost of acquisition. In particular, the account can be an online bank account from which electronic checks are drawn, or the account can be a credit card account of user 112. Examples of good or service providers that fulfill the request include a user (“provider-seller”) 102 and any third party good or service (“G/S”) provider 116 that are configured to interact with provider aggregator system 120. Any of user 102 or third party provider 116 can be described as “a goods or services provider,” according to some embodiments.

Diagram 100 also includes a number of payment processor entities 130 and a number of financial data processors 140. Payment processor entities 130 are representative of one or more of payment processor entities 132, 134, and 136, and financial data processors 140 are representative of one or more of financial data processors 142, 144, and 146. In operation, payment processor entities 132, 134, and 136 each are configured to process financial transactions of various electronic financial instruments, such as credit cards, electronic checks (“echecks”), cash transactions and equivalent substitutes, and the like, on behalf of provider aggregator system 120 or the parties involved with the order and constituent financial transactions. Financial data processors 142, 144, and 146 each are configured to process financial-related data for electronic financial accounts responsive to payment-related requests (e.g., payments, requests to void transactions, cancellations, escrow requests, etc.). The electronic financial accounts are associated with third party providers 116, user 102, and user 112, and are configured to receive payment from user 112 into an account for a third party provider. Note that the electronic financial accounts for third party providers 116 and user 102 can be described as merchant accounts, at least in some examples.

Provider aggregator system 120 is configured to offer goods and services provided by user 102 or any third party provider 116, either of which can be described as a goods or services provider. Further, provider aggregator system 120 is configured to facilitate payment for the order as an aggregated electronic transaction 170, which is, for example, transmitted to payment processor entity 134, after which payments 172a, 172b, and 172c can be transmitted (e.g., in parallel) to one or more of financial data processors 142, 144, and 146. Once payment is received, a message 174 is transmitted to third party provider 116 to indicate the purchaser fulfilled their obligation. In one embodiment, data representing payment may also be transmitted as a portion of message 174. In some embodiments, provider aggregator system 120 is configured to principally promote the sale or rental of a good or service via a web portal provided by user 102 (i.e., user 102 is a principal merchant). Provider aggregator system 120 also is configured to promote the sale or rental of a good or service of third party providers that can provide ancillary goods and services in conjunction with the order for the good or service provided by user 102. Note that user 102 can be an individual, corporation, an organization, or the like that is offering, for example, new automobiles for sale or home properties for rent. Third party providers 116 can provide ancillary goods and services, such as automotive-related goods (e.g., floor mats, paint treatments, etc.), for automobiles, whereas third party providers 116 can provide ancillary goods and services, such as rental insurance, cleaning fees, etc., for rental properties.

As shown, provider aggregator system 120 is a system including a provider processing engine 122, a payment administration manager 124, and a split payment engine 126. Provider processing engine 122 is configured to interact with user 112, user 102, and/or one or more third party goods or services providers 116 via, for example, one or more networks (not shown) implementing one or more communication protocols. For example, a network can include the Internet, an Automated Clearing House (“ACH”) network, and the like. In some examples, provider processing engine 122 includes a web server (and/or equivalent structures to provider web server functionalities) to host web pages for offering the goods and services of user 102 and one or more third party goods or services providers 116 for sale or rent. Therefore, provider aggregator system 120 can generate data to present web pages on computing device 114 to, for example, principally sell or rent a “principal” good or service provided by user 102. Other ancillary goods and services, which can be subsidiary to the sale of the principal good or services, can also be offered for sale on the web page. In some cases, the identities of the third party providers need not be presented on the web page displayed on computing device 114. Further, provider processing engine 122 can be configured to communicate inquiries, quotes, agreements, and reservations between user 102 and 112, and can be configured further to facilitate payments and reverse payments (e.g., refunds) between user 112 or any goods or services provider.

Provider processing engine 122 can be configured to accept via computing device 114 data representing one or more purchase selections relating to offered goods and services, as well as data representing authorization to pay for such goods and services. It also can be configured to exchange communications between computing device 114 and goods or services providers to facilitate a partial or full refund without provider aggregator system 120 directly processing such a transaction (i.e., provider aggregator system 120 avoids functioning as a merchant-of-record), at least in some embodiments. By employing split payment engine 126, which is discussed below, provider aggregator system 120 facilitates transactions 176 to, for example, provide refunds and other financial transactions via transaction channel 180 from a bank associated with third party provider 116 (e.g., one of financial data processors 140) to a credit card account for user 112. In this example, transaction facilitation channel 180 is or conceptually represents a communication path for conveying information sufficient to enable one of payment processor entities 130 to perform a payment transaction, whereby data on transaction facilitation channel 180 is accessible to, for example, payment administration manager 124, which is described below, for purposes of analyzing orders to track payments and reverse payments among user 102, user 112, and third party providers 116. Also, provider processing engine 122 can be configured to transmit data 115 representing the order as an aggregated transaction. For example, data 115 can include, or can form part of, a consolidated statement or receipt to user 112, whereby the data represents a purchase amount as an aggregate cost over the goods and services. The consolidated statement can be, for example, credit card account statement in which the payment for the order for multiple goods and services is presented as a single aggregated electronic payment. Thus, user 112—as recipient-buyer—can more readily perceive that provider aggregator system 120 is the purveyor of the goods and services offered by third party good and service providers and by user 102.

Split payment engine 126 is configured to perform a split payment operation to apply electronic funds against the purchaser's account, for example, via one of payment processor entities 130. In some embodiments, split payment engine 126 can be configured to cause aggregation of financial transactions as a single aggregated electronic transaction. Aggregation of the financial transactions can occur in either split payment engine 126 or payment processor entity 134, or both, or in any other component depicted in diagram 100. Further, split payment engine 126 can be configured to operate in a fail-safe manner (i.e., the order fails safely by negligibly affecting at least the financial position purchaser and/or their account). In particular, that split payment engine 126 can be configured to initiate fulfillment of the transactions in which goods or services are exchanged for the transactions if a principal good or service and one or more ancillary good and services are capable of being fulfilled. But if any of the principal good or service and the ancillary good and services is not capable of being fulfilled, then split payment engine 126 is configured to cause the order request to roll-back each of the financial transactions. To illustrate, consider that split payment engine 126 is configured to operate in at least two states. In operating in a first state, each provider (e.g., user 102 and third party providers 116) of multiple goods or services is capable fulfilling an order request from user 112, and when operating in a second state, at least one transaction with a provider of the multiple goods or services is not capable of fulfilling an item (i.e., a good or service) for the order. In the first state, split payment engine 126 causes transmission of payment transactions via payment processor entity 134 to each provider of the multiple goods or services, whereby the individual payment transactions are collectively represented as a single transaction 170 (e.g., single aggregated electronic transaction) in association with the account. According to some embodiments, an order is reflected in the account of user 112 as a single payment (e.g., a single credit card payment) rather than multiple charges to each provider. In the second state, split payment engine 126 is configured to “roll back” the transaction request to ensure that none of the providers of the multiple goods or services are requested to provide the multiple goods or services in the request. That is, none of the payment transactions are transmitted to the providers of the multiple good or services, and, thus, the purchaser does not incur charges related to the failed order. In some embodiments, payments 172a, 172b, and 172c may be batched (e.g., at night) for transmission at a specific time, whereby one or more payments 172a, 172b, and 172c (e.g., payments constituting transaction 170) may be rolled back before transmission from one of payment processor entities 130 should at least one of the payment transactions cannot be fulfilled. In view of the foregoing, split payment engine 126 is configured to “split” payments of an otherwise single aggregated electronic transaction (e.g., as presented to the purchaser and their account) into separate payments in a fail-safe manner, whereby computing device 108 and provider aggregator system 120 has access to all (or nearly all) financial data passing through provider aggregator system 120, including data exchanged between third party provider 116 and payment processor entity 134.

Payment administration manager 124 is configured to effect customer support provided, for example, by an administrator (“admin”) 110 via computing device. For example, payment administration manager 124 monitors data in split payment engine 126 and other components of provider aggregator 120, and, in some cases, includes logic configured to capture financial-related transactions not only between user 102 and user 112, but among user 112 and the goods and services providers, including third party providers 116. Administrator 110 can be a user of payment administration manager 124 and can facilitate financial transactions, such as, for example, modifying amounts and issuing refunds. Payment administration manager 124 can be also configured to analyze transaction histories to decipher or discern trends and to track and identify each transaction in the context of an over-arching order. Split payment engine 126 can optionally include a transaction correlator 190 configured to assign a correlation identifier to a subset of transactions associated with an order, including payment transactions, refund transactions, void transactions, cancellation transactions, and the like. Payment administration manager 124 is configured to use the correlation identifier to track financial activity associated with the order, and to optimize, at least in some instances, payment-related transactions in which payment processor entity 134 is involved.

In view of the foregoing, a provider aggregator and/or a split payment engine of the various embodiments, as well as the processes of using the same, can provide the structures and/or functionalities for processing electronic transactions, including financial-related transactions, to fulfill and correlate online orders of goods and services offered by multiple provider entities hosted by a principal entity. Split payment engine 126 is configured to “split” payments of an otherwise single aggregated electronic transaction (e.g., as presented to the purchaser and their account) into separate payments without serial limitations (e.g., in parallel) and in a fail-safe manner so that in the aggregate, the transactions either all succeed or none of the transactions succeed. Thus, split payment engine 126 thereby provides for either a successful aggregated electronic transaction or a failed aggregated electronic transaction. Therefore, the purchaser is not obligated to pay for first item if a second item, which is required by the first item, is not available. For example, if user 112 submits a request to charge a rental house payment and an insurance payment for the rental house, a successful transaction to acquire insurance is of no value to the purchaser if, for whatever reason, the transaction for the rental house does not succeed. In some embodiments, split payment engine 126 is configured to generate (or cause to generate) an aggregated electronic transaction 170 in which one of payment processor entities 130 either secures payment for each item of the order or none of the items. Therefore, provider aggregator system 120 need not function as a merchant-of-record, and, thus, need not be liable for processing payments as a party to the financial transaction. Line 129 specifies a line of demarcation between the responsibility of a party to the financial transaction (e.g., a payment processor) and a non-party (e.g., provider aggregator). As such, one of payment processor entities 130 assumes at least some responsibility for the financial risks, such as charge-back risks and other similar risks, whereas provider aggregator system 120 need not assume such risks or otherwise subject itself to certain financial liabilities.

In some embodiments, line 127 specifies a legal, a regulatory, and/or a foreign line of demarcation, whereby provider aggregator system 120 offers a good and service by a third party provider that it otherwise may decide not to provide due to legal, regulatory or jurisdictional issues. Certain regulations and/or laws (domestic or foreign) may prohibit or otherwise frustrate the ability of provider aggregator system 120 to offer an ancillary good or service. For example, consider that provider aggregator system 120 is configured to offer home properties for rent. As the provisioning of insurance is typically a regulated industry, provider aggregator system 120 may be prohibited from accepting payment for insurance if it is not licensed to do so. Therefore, split payment engine 126 provides a transaction channel 180 through which financial-related transactions can be facilitated by provider aggregator system 120 without making provider aggregator system 120 a party (e.g., as a merchant-of-record) to the financial transaction. Further, transaction correlator 190 can be configured to assign a correlation identifier with which provider aggregator system 120 can use to track the evolution of an order during which financial activity can include additional payments, refunds, cancellations, voided transaction, and the like. By implementing correlation identifiers, split payment engine 126 or one of payment processor entities 130, or both, can operate to optimize an electronic transaction. For example, if two payment transactions to the same third party provider are detected, then the two payment transactions can be aggregated into one transaction. In some cases, a total amount of fees associated with the aggregated transaction (e.g., an interchange fee) is less than the total amount of fees for two similar transactions (i.e., two fees incurred rather than one fee). Further, certain types of transactions have different fee structure amounts. As such, a financial transaction, such as a refund request, can be substituted by a void transaction, which may cost less than request a refund while accomplishing the intended goal (e.g., return funds to the purchaser). Therefore, transactions can be optimized to, among other things, reduce costs for a payment processor.

Examples of payment processor entities 132, 134, and 136 include gateways, such as payment gateways, or any other entity including one or more servers (including one or more processors) and storage media and/or repositories (e.g., memory, including databases) that store algorithms including executable instructions configured to implement the various functions described herein. In specific, but non-limiting examples, payment processor entities 132, 134, and 136 can be implemented as or part of payment processing services provided by YapStone, Inc.™ of Walnut Creek, Calif., Payment Processing, Inc.™ (“PPI”) of Newark, Calif., and the like.

Examples of financial data processors 142, 144, and 146 include financial accounts stored as data in storage media and/or repositories (e.g., memory, including databases) at online bank entities or any other entity including one or more servers (including one or more processors). The repositories are configured to store financial data and/or algorithms including executable instructions configured to implement the various functions described herein.

As depicted in FIG. 1 and subsequent figures, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, the above-described techniques may be implemented using various types of programming or formatting languages, frameworks, syntax, applications, protocols, objects, or techniques. For example, any of elements in FIG. 1 (or any subsequent figure) can represent one or more algorithms. Or, any of the elements can represent a portion of logic including a portion of hardware configured to provide constituent structures and/or functionalities.

For example, any of provider aggregator system 120 (including one or more components, such as provider processing engine 122, payment administration manager 124, and split payment engine 126), payment processor entities 130, and financial data processors 142 can be implemented in one or more servers including one or more processors configured to execute one or more algorithms in memory. Thus, any of elements in FIG. 1 (or any subsequent figure) can represent one or more algorithms. Or, any of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, any of provider aggregator system 120 (including one or more components, such as provider processing engine 122, payment administration manager 124, and split payment engine 126), payment processor entities 130, and financial data processors 142 can be implemented in one or more computing devices including one or more circuits. Thus, any of elements in FIG. 1 (or any subsequent figure) can represent one or more components of hardware. Or, any of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof. According to some embodiments, the term “engine” can refer, for example, to an algorithm or a portion thereof, and/or logic implemented in either hardware circuitry or software, or a combination thereof (i.e., an engine can be implemented in as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

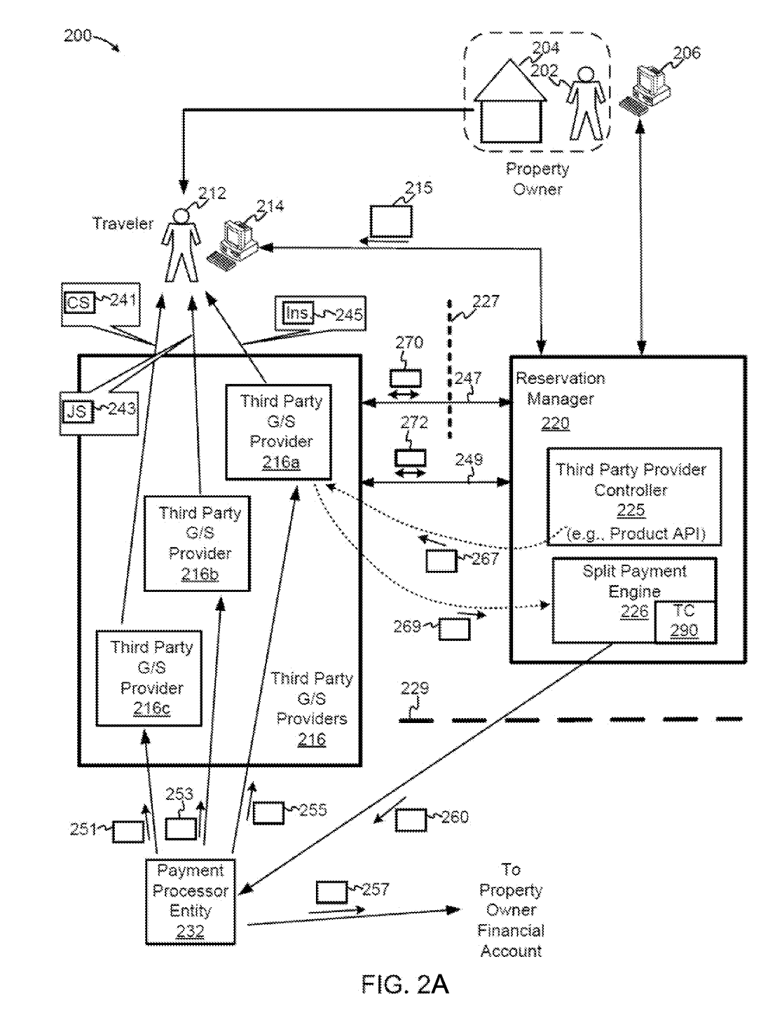

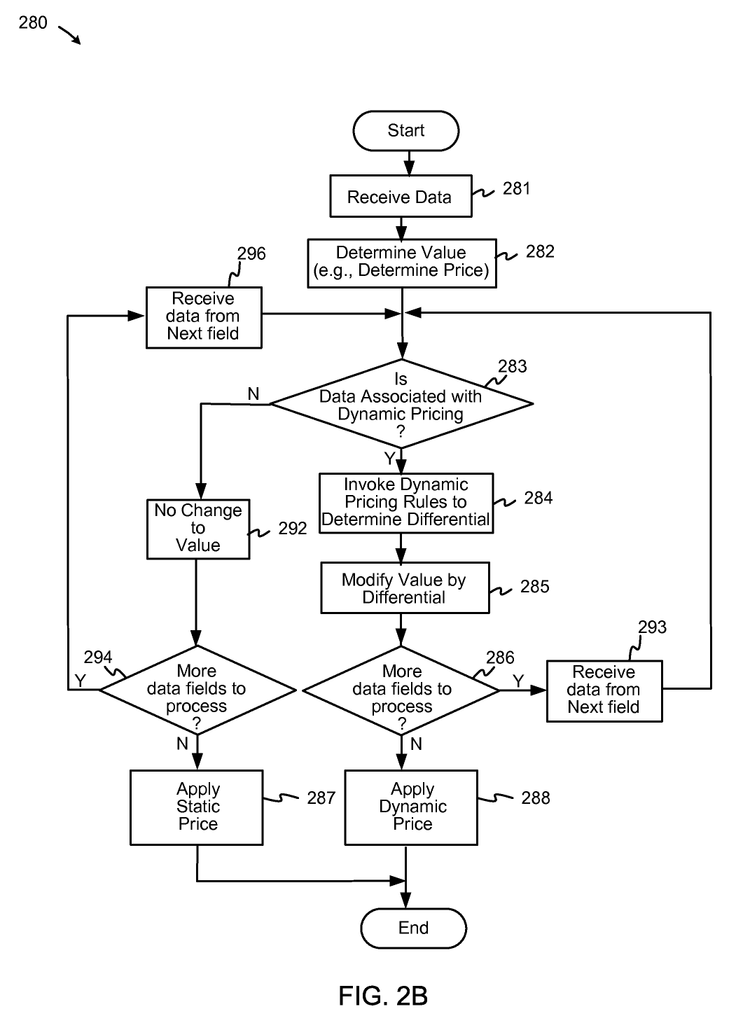

FIG. 2A illustrates an example of a system that includes a split payment engine to cooperate with a payment processor, which provides online electronic payments as a service, for the fulfillment of a principal service of renting property and ancillary goods and services, according to some embodiments. Diagram 200 depicts a reservation manager system 220 configured to receive data representing a request by, for example, a user (“traveler”) 212, from a purchaser computing device 214, to rent property 204 associated with property owner 202 (e.g., a home owner), and optionally, purchase one or more goods or services, such as cleaning service (“CS”) 241, jet ski rental service (“JS”) 243, and insurance service (“Ins.”) 245 from different good or service providers. While goods or services 241, 243, and 245 can generally be ancillary to the renting of property 204, they need not be ancillary. Note that the term “property,” can refer to any real or personal property, including single family homes, condominiums, warehouses, offices, hotel rooms, resort packages, time share-based properties, etc.

In some embodiments, reservation manager system 220 can include one or more structures set forth in provider aggregator system 120 and can be configured to provide one or more function of provider aggregator system 120. For example, reservation manager system 220 can include provider processing engine 122 and payment administration manager 124 of FIG. 1, at least in some instances. As shown in FIG. 2A, reservation manager system 220 includes a third party provider controller 225 and a split payment engine 226. Third party provider controller 225, under control of reservation manager 220, is configured to select a payment processor for a third party provider 216, such as third party provider 216c (e.g., an insurance provider). The payment processor, such as payment processor entity 232, serves as a gateway to effect financial transactions. As shown, line 229 represents a line of demarcation between the responsibility of a party to the financial transaction (e.g., a payment processor) and a non-party (e.g., reservation manager 220). As such, payment processor entity 232 (or equivalent) assumes at least some or all responsibility for the financial risks, such as charge-back risks and other similar risks, whereas reservation manager system 220 need not assume such risks or otherwise subject itself to certain financial liabilities. Line 227 specifies a legal, a regulatory, and/or a foreign line of demarcation, whereby reservation manager system 220 offers a good and service by any third party provider 216a, 216b or 216c that it otherwise may decide not to sell due to legal, regulatory or jurisdictional issues. Certain regulations and/or laws (domestic or foreign) may prohibit or otherwise frustrate the ability of reservation manager system 220 and/or its owner to offer an ancillary good or service, such as insurance (“ins.”) 245, which is typically a regulated product. The sale of such goods or services may require a license or may subject the purveyor of reservation manager 220 to other regulatory or jurisdictional (e.g., foreign law) impediments.

To illustrate operation of reservation manager 220, consider the following example. Traveler 212 via computing device 214 requests a reservation for home 204, and home owner 202 responds via computing device 206 in agreement. Reservation manager 220 is configured to facilitate the rental of home 204, and to facilitate payment for the same. Further, consider that third party provider controller 225 is configured to facilitate reservation of ancillary goods and services 216, which can be ancillary to renting home 204, and to facilitate payments of the same. In this example, traveler 212 selects for purchase a rental insurance policy 245 from third party provider 216a, which is an insurance provider, a jet ski rental (“JS”) 243 from third party provider 216b, which is an entity that rents jet skis, and a cleaning service (“CS”) 241 for cleaning home 204 from third party provider 216c, which can be a cleaning service (e.g., a maid service independent of home owner 202).

To facilitate reservations and payment, third party provider controller 225 can be configured to facilitate communications, for example, responsive to requests and/or inputs from computing devices 214 and 206. Examples of data communications include messages 270 and 272. Data communications via communications path 249 represents messages 272 exchanged between third party provider controller 225 and third party providers 216b and 216c for purchases of associated goods and services 243 and 241, respectively, neither of which are regulated goods or services. By contrast, data communications via communications path 247 represents messages 270 exchanged between third party provider controller 225 and third party provider 216a for purchase of insurance product 245, which is a regulated good or service.

Once the goods and services associated with the initial order or reservation are confirmed, reservation manager 220 causes split payment engine 226 to initiate payment, for example, in a fail-safe manner, whereby payments to property owner 202, third party provider 216a, third party provider 216b, and third party provider 216c “roll back” if at least one of the payments is not able to be completed. Further to the example, consider that split payment engine 226 transmits or causes transmission of an aggregated electronic transaction 260 (e.g., an aggregated payment), from which payment processor 232 transmits payment 257 to owner 202 (or an associated account), payment 251 to third party provider 216c (or an associated account), payment 253 to third party provider 216b (or an associated account), and payment 255 to third party provider 216a (or an associated account). Reservation manager 220 is configured to generate data representing a statement 215 indicating the purchase of a subset of the various goods and services is a singular transaction (e.g., an aggregated transaction) represented by an aggregated payment 260. Note that statement 215 need not be so limiting, and, in some cases, can present individual payments 251, 253, 255, and 257. Optionally, transaction correlator 290 can be included to assign a correlation identifier to the subset of transactions associated with the reservation for correlating data, including payment-related data.

Subsequent to the initial payment, third party provider controller 225 is configured to facilitate modifications to the financial positions of owner 202 and third party providers 216 responsive to various subsequent transactions with traveler 212. For instance, consider that traveler 212 is owed a refund from third party provider 216a because traveler 212 has requested a change from insurance product 245 to one with a higher deductible (i.e., at lower purchase cost). Note that traveler 212 also can add or supplement coverage. The request 267 for insurance modifications is transmitted to third party provider 216a from third party provider controller 225, after which third party provider 216a initiates an electronic transaction request 269 to split payment engine 226 to either refund an amount to the account associated with the traveler or to make payment for additional coverage. As described above, reservation manager 220 and/or elements thereof can be implemented in logic, circuits, algorithms, hardware or software, or any combination thereof. Examples of third party providers 216a for insurance include, without limitation, CSA Travel Protection® owned by CSA of California/Europ Assistance of Paris, France, Mondial Assistance SAS™ of France, and other like travel insurance provider entities.

Third party provider controller 225 can be configured to apply business rules to one or more transactions for traveler 212 or owner 202, the business rules either being provided by an entity owning reservation manager 220 or any third party provider 216. For example, a rule provided by third party providers 216 can provide for static or dynamic pricing, as well as discounts for bundling with one or more other items ordered. An example of another is as follows. Consider that “double insuring” is not permitted by a third party provider 216a as an insurance provider. Thus, third party provider 216a can generate a rule for use by third party provider controller 225, which is configured to reject requests for multiple insurance policies for the same property during the same reservation period. Also, third party provider controller 225 can instruct split payment engine 226 to make payment to an escrow account (not shown) on behalf of the purchaser until some conditions are satisfied. Other examples of third party providers 216 include stables that provide horseback riding services, car rental agencies, restaurants, tour guides, and any other good or service provider that can provide goods and services ancillary to the reservation for renting property 204. In at least some embodiments, third party provider controller 225 and its components are implemented as a specification and/or executable instructions to form a product applications specific interface (“API”), or any number of APIs.

FIG. 2B is an example of a flow for implementing dynamic data processing, according some embodiments. In some examples, dynamic data processing can include dynamically modifying an aspect of a transaction, such as pricing, based on data or other aspects of a transaction. As shown, flow 280 includes receiving data at 281, which can be received into, for example, third party provider controller 225 of FIG. 2A. At 282, a data value can be determined that is associated with a transaction. In some examples, the data value represents a price for the transacted good or service. In other examples, the data value can represent a model of a car being rented (e.g., a higher-end model of a selected rental car may be substituted for a lower-end model based on predetermined criteria, such as the age or other demographic informations or conditions).

Returning to flow 280, a determination is made at 283 whether data entered into a field, for instance, is associated with the used of dynamic pricing. If yes, flow 280 proceeds to 284, otherwise flow 280 moves to 292 at which no change is made to the value (e.g., no change is made to the price). If no other data fields are to be processed at 294, then flow 280 proceeds to 287 at which a statically-determined price is used. Otherwise, flow 280 moves to 296 at which additional data is received to determine whether dynamic pricing may be implemented.

At 284, dynamic pricing rules may be invoked to determine a differential with which to modify a price. For example, in the transaction involving a rental car, dynamic pricing can alter a price by selecting a differential (e.g., an amount that is added to or subtracted from a price). The amount of the differential can be determined by an age of the primary driver for a car rental offer, or whether a history exists of prior accidents or poor driving habits (e.g., based on past rentals in which GPS, acceleration, speed, and other like data is monitored to determine risk levels of drivers). Data representing, for example, zip code of a person renting a car may also influence the price of a car rental. As another example, an age of a traveler may influence a cost of an activity, such as a fishing trip. Fishing licenses need not be included in the cost of a fishing trip if the person fishing is, for example, below the age of 16 years old. An example of a differential that reduces a price is a condition in which a traveler uses the service “X” amount of times, and, in response, receives a 10% discount for a booked trip.

At 285, the value is modified by the determined differential, such as by increasing the value or price by a positive differential or decreasing the price by a negative differential. Should there be more data field to process at 286, flow 280 moves to 293 at which data is received for the next field. Otherwise, flow 280 proceeds to 288 at which a dynamically-determined price is used.

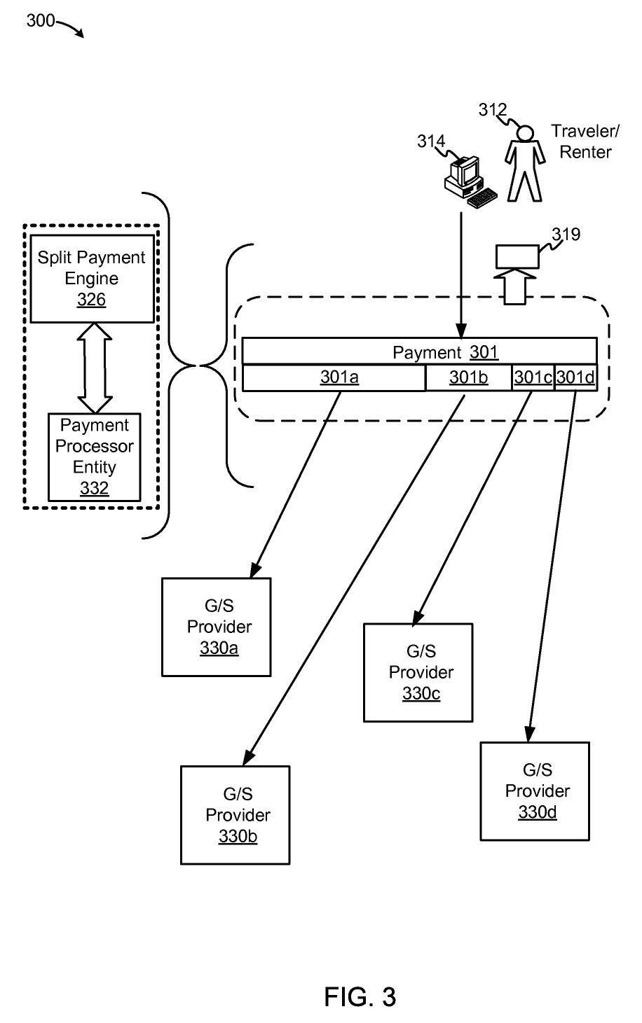

FIG. 3 illustrates an aggregated electronic transaction, according to some embodiments. Diagram 300 depicts a split payment engine 326 and a payment processor entity 332 configured to cooperate to cause generation of an aggregated electronic transaction as, for example, an aggregated electronic payment 301, for example, as perceived by traveler 312 via computing device 314. Split payment engine 326 is configured to cause payment processor entity 332 to generate split payment 301a (e.g., rental property fee) to good or service (“G/S”) provider 330a (e.g., a home owner), split payment 301b (e.g., insurance payment) to good or service provider 330b (e.g., an insurance company), split payment 301c (e.g., jet ski rental fee) to good or service provider 330c (e.g., a jet ski owner), and split payment 301d (e.g., cleaning service fee) to good or service provider 330d (e.g., a cleaning service). Therefore, an account 319 for traveler 312 can be charged an amount for payment 301 rather than for individual payments 301a, 301b, 301c, and 301d.

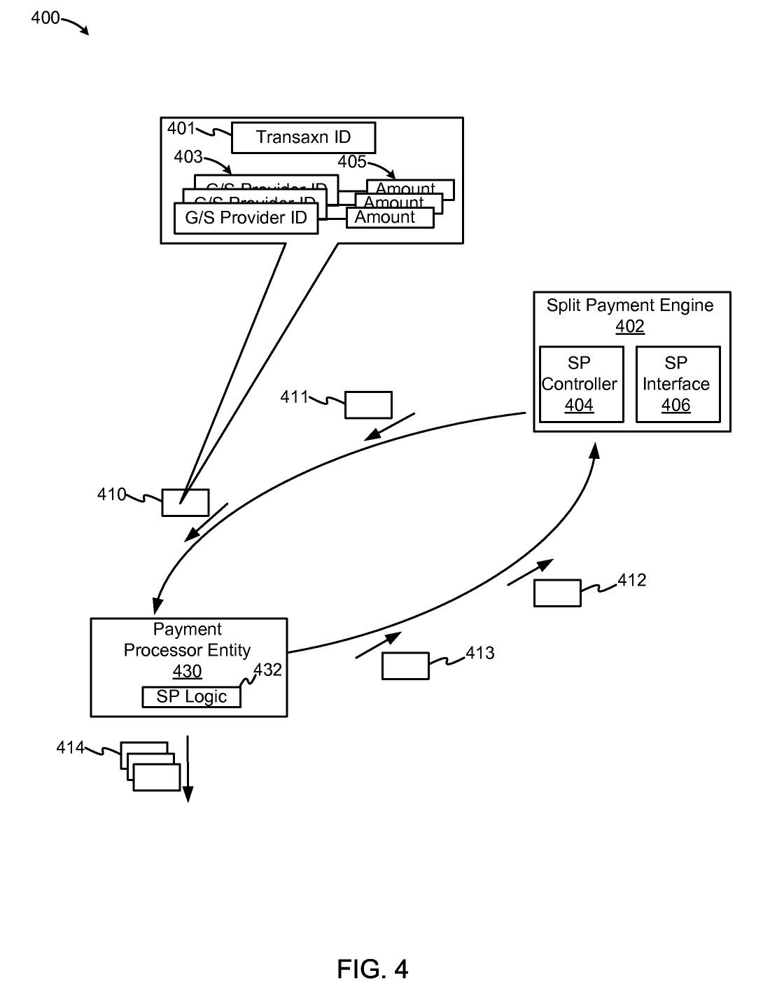

FIG. 4 illustrates an example of a split payment engine, according to some embodiments. Diagram 400 depicts a split payment engine 402 and a payment processor entity 430 configured to cooperate to cause generation of an aggregated electronic transaction to generate split payments 414 to different goods or service providers, whereby payment transactions can be reconciled in a single step of reconciliation. As shown, split payment engine 402 can include a split payment (“SP”) controller 404 and a split payment (“SP”) interface 404, either of which may be absent. Payment processor entity 430 is shown to include split payment (“SP”) logic 432, at least in some cases. According to various embodiments, some or all the logic to effectuate split payments can be disposed in split payment engine 402. In some embodiments, split payment engine 402, or portions thereof, can reside within payment processor entity 430.

In accordance with a first implementation, split payment engine 402 includes logic to perform at least a portion of functionality for generating an aggregated electronic transaction, according to various embodiments. In one implementation, split payment controller 404 is configured to assign a transaction identifier (“transaxn ID”) 401 to a group of goods and services (“G/S”) provider identifiers (“IDs”) 403 and amounts 405, and is further configured to transmit those goods and services provider identifiers 403 and amounts 405 via, for example, data message 410. In some embodiments, data message 410 is an aggregated electronic transaction as it includes multiple transactions (e.g., multiple line items) to be completed in a fail-safe manner. Data message 410 can also include instructions with which split payment logic 432 is to disburse among multiple sub-accounts (e.g., accounts associated with the payees). Split payment logic 432 is configured to determine whether payment to each goods and services provider identifier 403 and amount 405 can be successfully transacted. For example, split payment logic 432 determines whether each payment is authorized by, for example, a credit card-issuing bank that indicates that the purchaser has sufficient credit or funds in an account. In some instances, split payment logic 432 determines whether each payment is authorized in series or substantially in series. If each of the payments is authorized, then payment processor entity 430 can transmit payments 414 and a data message 412 indicating such transactions have been made. In response, split payment interface 406 generates another data message (not shown) indicating successful payment has been made in the aggregate, and the payments can be characterized as an aggregated electronic transaction. But if split payment logic 432 determines that at least one payment cannot be completed, an error message 413 is transmitted indicating a failed transaction. In response, split payment interface 406 generates a message (not shown) to cancel the order or reservation.

In accordance with a second implementation, split payment engine 402 includes logic to perform a preponderant amount or all of the structure and/or functionality for generating an aggregated electronic transaction, according to various embodiments. In this implementation, split payment controller 404 is configured to transmit goods and services (“G/S”) provider identifiers (“IDs”) 403 and amounts 405 via, for example, one data message 410 or multiple data messages 410 to payment processor entity 430. In some instances, multiple data messages 410 can be sent in parallel or substantially in parallel. Split payment logic 432 is configured to determine whether each request for payment to each goods and services provider identifier 403 and amount 405 can be successfully transacted. If so, then payment processor entity 430 can either transmit payments 414 or it can transmit a data message 412 indicating such transactions are possible. In response, split payment interface 406 generates another data message 411 authorizing payment processor entity 430 to remit payments. But if split payment logic 432 determines that at least one payment cannot be completed, an error message 413 is transmitted indicating a failed transaction. In response, split payment interface 406 generates a message (not shown) to cancel the order or reservation.

According to at least one embodiment, split payment engine 402 and/or its components are implemented as a specification and/or executable instructions to form an applications specific interface (“API”), or any number of APIs. In various embodiments, a split payment engine API can be disposed in, for example, a payment processor entity or in a reservation manager. Functionalities of a split payment engine API can be distributed among multiple computing devices including processors and memory. According to some embodiments, split payment engine 402 is an API formed based on a REST (“REpresentational State Transfer”) architecture, and split payment engine 402 includes a ReST interface to cause generation of an aggregated electronic transaction.

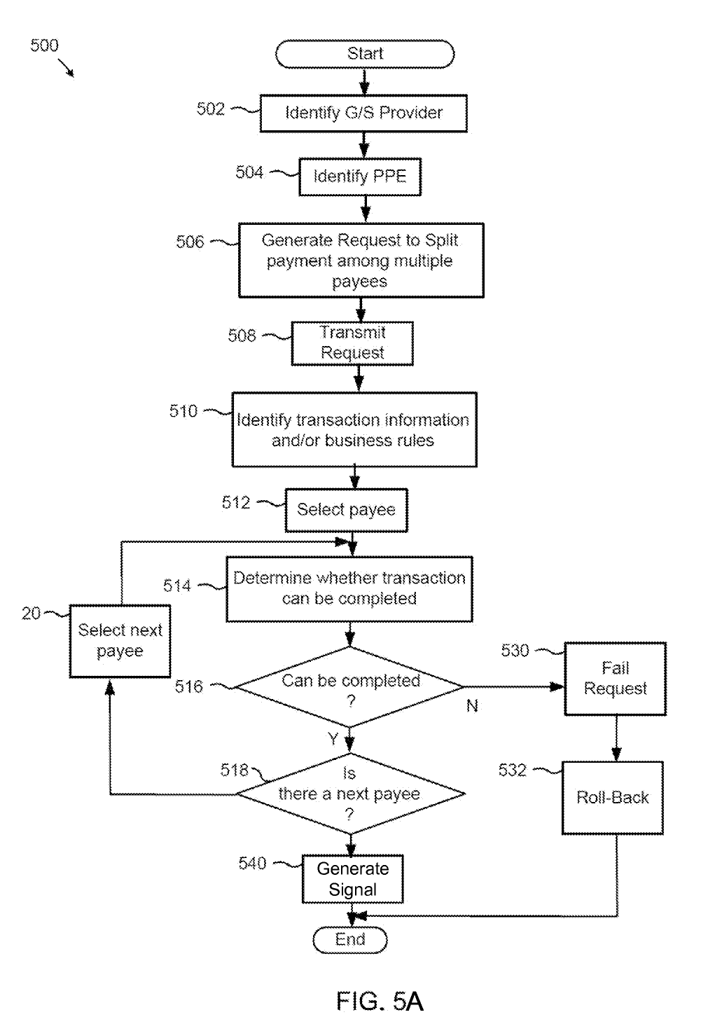

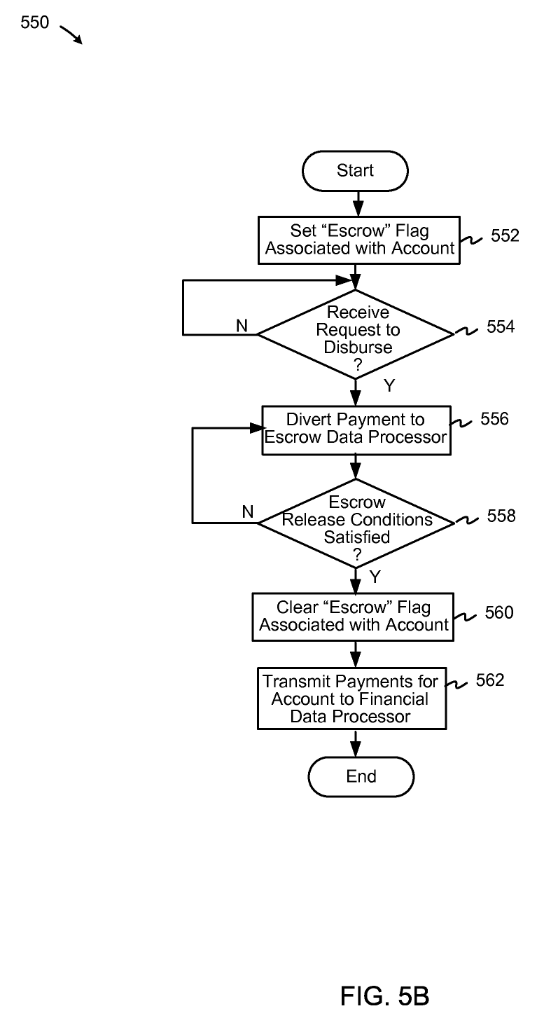

FIG. 5A is an example of a flow 500 of splitting payments according to some embodiments. Flow 500 begins by identifying one or more good or service providers at 502, including principal and ancillary good or service (“G/S”) providers. For example, a property identifier associated with a rental property can be identified. At 504, a payment processor entity is identified. For example, if the principal good or service provider uses a particular payment processor entity (“PPE”) as a specific gateway, then that payment processor entity can be used for the good or service providers associated with the order or reservation. At 506, a request is generated to split a payment among multiple good and service providers (e.g., an aggregated amount charged to a purchaser is split among multiple payees). The request is transmitted at 508 (e.g., a request can be for payment or reverse payment, such as a refund). For example, the request can be transmitted from a split payment engine to a payment processor entity. Further, the request can be transmitted within a payment processor entity that includes, for example, a split payment engine API. At 510, the request is filtered against transaction-related information and/or business rules configured to define conditions in which one or more payments can be made based on a request for split payment. For example, a request for payment for a second insurance policy that results in double insuring is to be rejected at 510. As another example, a property owner may prohibit full refunds 14 days before a renter is to take possession of the rental home. Therefore, requests for full refunds during the period of 14 days are to be denied. Another business rule can specify that payments to certain third party providers are to be held in an escrow account until some predetermined condition (e.g., the traveler arrives at a jet ski rental shop and provides a confirmation number). Yet other examples of business rules include discounts for ancillary goods and services if purchased in accordance with conditions set by third party providers. At 512 a payee (e.g., a good or service provider) is selected to determine whether a financial transaction can be transacted at 514. At 516, a determination is made whether the transaction can be completed. If not, the split payment request fails at 530 and each transaction tagged for payment is rolled back at 532. For example, pending credit card transactions are voided and pending electronic check (“eCheck”) transactions are canceled. But if the transaction can be completed, flow moves from 516 to 518 at which a determination is made whether there is next payee. If so, flow 500 selects the next payee at 520. When no further payees are identified at 518, flow 500 moves to 540 at which a signal is generated to include data representing an indication that funds may be disbursed to selected payees. In some examples, disbursement may occur at a specific time (e.g., at night) and may be batched by, for example, payment processor entities, such as payment gateway providers. Disbursement can be initiated by the payment processor entities responsive to the signal generated at 540 (e.g., if the signal does not data representing a request to void or cancel a transaction).

FIG. 5B is an example of a flow 550 of implementing an escrow data processor for a provider of goods or services, according to some embodiments. In some examples, flow 550 can be implemented prior to 540 of FIG. 5A (at which a signal may be generated to disburse some or all funds for a portion of a transaction). In instances in which a merchant is new or has had a suboptimal credit history, some or all funds may be diverted into an escrow account. For example, a new jet ski operator may have limited financial history, which may indicate insufficient information exists to determine its creditworthiness. Therefore, to reduce instances of fraud, a new account for a new provider of goods or services may be flagged. At 552, an escrow flag associated with an account is set, thereby causing funds to be diverted to an escrow data processor at 556 subsequent to a request to disburse funds. At 558, a determination is made as to whether conditions exist to release the provider of goods or services from mandatory escrow diversions. For example, if the provider of goods or services builds sufficient credit history, then the escrow flag can be cleared at 560, which subsequent payments being transmitted to the provider's financial data processor 562 without being diverted into escrow.

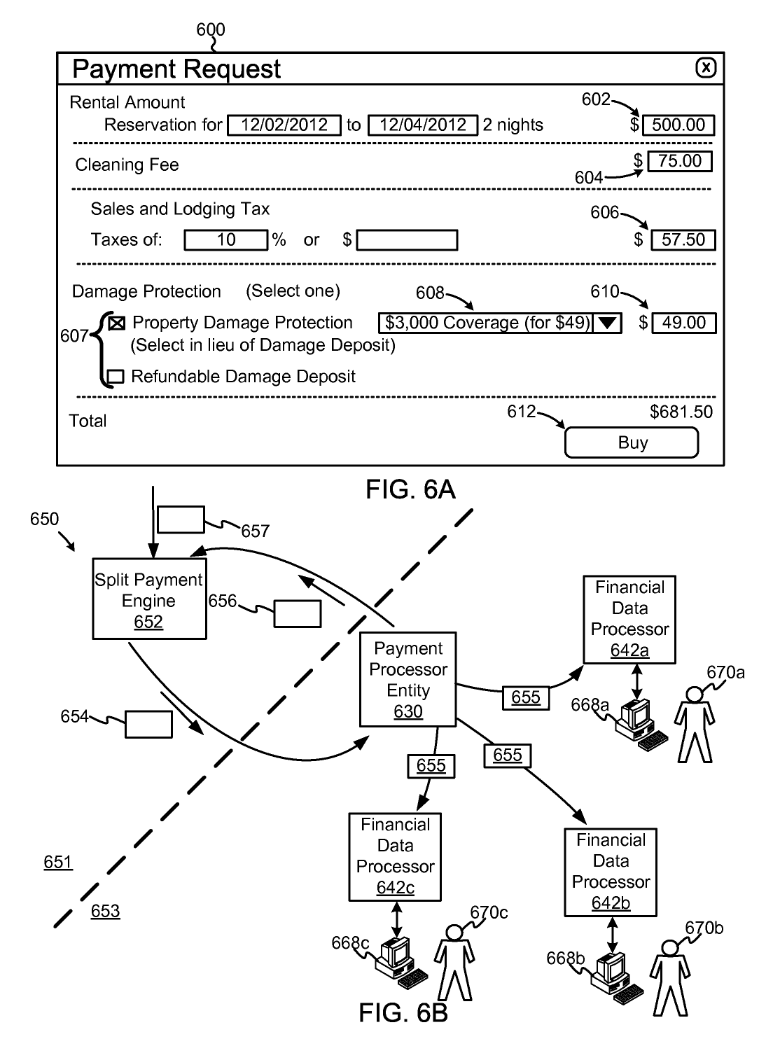

FIGS. 6A and 6B depict a user interface and functional diagram, respectively, of a payment request for multiple goods and services providers, according to some embodiments. Diagram of FIG. 6A depicts a user interface 600, for example, generated by provider aggregator system and/or a reservation manager for presentation on a display of a purchaser computing device. As shown, an amount 602 is for a rental home payment, an amount 604 is a cleaning service fee, an amount 606 is for taxes, and an amount 610 is for a certain level of insurance coverage requested in menu pull-down 608. A split payment request can be generated upon selection of input 612 to “buy” the items. As shown in diagram 650 of FIG. 6B, split payment request 654 is generated by a split payment engine 652 responsive to a request 657 originating in a non-party region 651 (i.e., an entity causing generation of request 657 is not a party to a financial transaction, and, thus, is not a merchant-of-record). Split payment request 654 is received by payment processor entity 630, which resides in a party region 653 (i.e., an entity causing generation split payments 655 is a party to the financial transaction, and thus is a merchant-of-record). Split payments 655 are received into financial data processors 642a, 642b, and 642c. Financial data processor 642a includes an account (e.g., an online-accessible financial account) for home owner 670a that is accessible via computing device 668a. Financial data processor 642b includes an account (e.g., an online-accessible financial account) for a cleaning service provider 670b that is accessible via computing device 668b. Financial data processor 642c includes an account (e.g., an online-accessible financial account) for a travel insurance provider 670c that is accessible via computing device 668c. Payment processor entity 630 generates a message 656 that the multiple electronic transactions have been completed for the payees, whereby the aggregated electronic transaction is charged, for example, to the purchaser's credit card account.

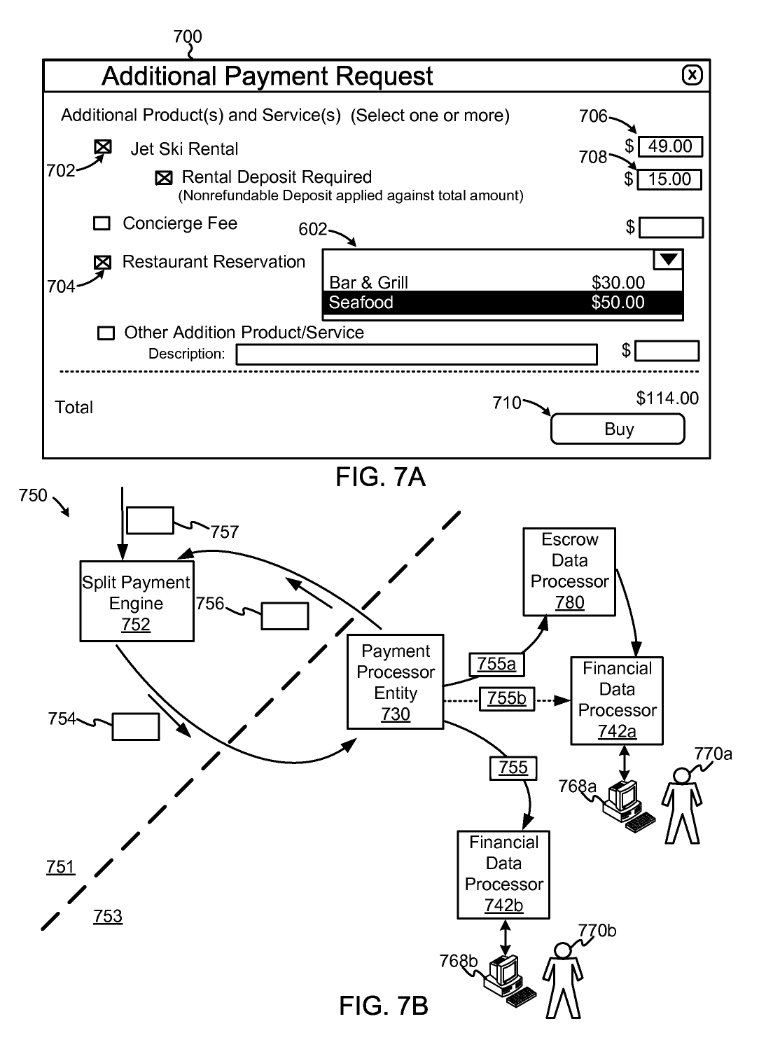

FIGS. 7A and 7B depict a user interface and functional diagram, respectively, of an additional payment request for multiple goods and services providers, according to some embodiments. FIG. 7A depicts a user interface 700, for example, generated by a provider aggregator system (or a reservation manager) for presentation on a display of a purchaser computing device. User interface 700 is depicting fields in which a purchaser (or traveler) can acquire additional goods and services in associated with the initial order. As shown, an input field 702 is selected for payment for a jet ski. An amount 706 is due upon arrival, and an amount 704 is for a nonrefundable deposit. Further, input field 704 is selected to reserve a table at a seafood restaurant selected in pull-down menu 602. A split payment request is generated upon selection of input 710 to “buy” the services. As shown in diagram 750 of FIG. 7B, split payment request 754 is generated by a split payment engine 752 responsive to a request 757 originating in a non-party region 751 (i.e., an entity causing generation request 757 is not a party to a financial transaction, and, thus, is not a merchant-of-record). Split payment request 754 is received by payment processor entity 730, which resides in a party region 753 (i.e., an entity causing generation split payments 755 is a party to the financial transaction, and thus is a merchant-of-record). Split payment 755 is received into financial data processor 742b, which includes an account accessible via computing device 768b for a restaurateur 770b. According to certain business rules, a nonrefundable deposit may be transmitted as payment 755b (as partial payment) to a financial data processor 742a, which includes an account accessible via computing device 768a for jet ski owner 770a. But the remainder of the payment 755a (e.g., jet ski rental price less the partial payment) is transmitted to an escrow data processor 780 that includes an escrow account to maintain payment 755a until some certain condition is met (e.g., the traveler arrives at the jet ski rental shop and provides a confirmation number, which, in turn, is entered into a reservation manager by the jet ski owner to release the remaining amounts). Note that in some embodiments, some or all of the price or payment may be transmitted to an escrow data processor or account until one or more conditions are met (e.g., a jet ski operator in the Bahamas is confirmed to operate a legitimate and creditworthy business). Payment processor entity 730 generates a message 756 specifying that the multiple electronic transactions have been completed for the payees, whereby the aggregated electronic transaction is charged, for example, to the purchaser's credit card account.

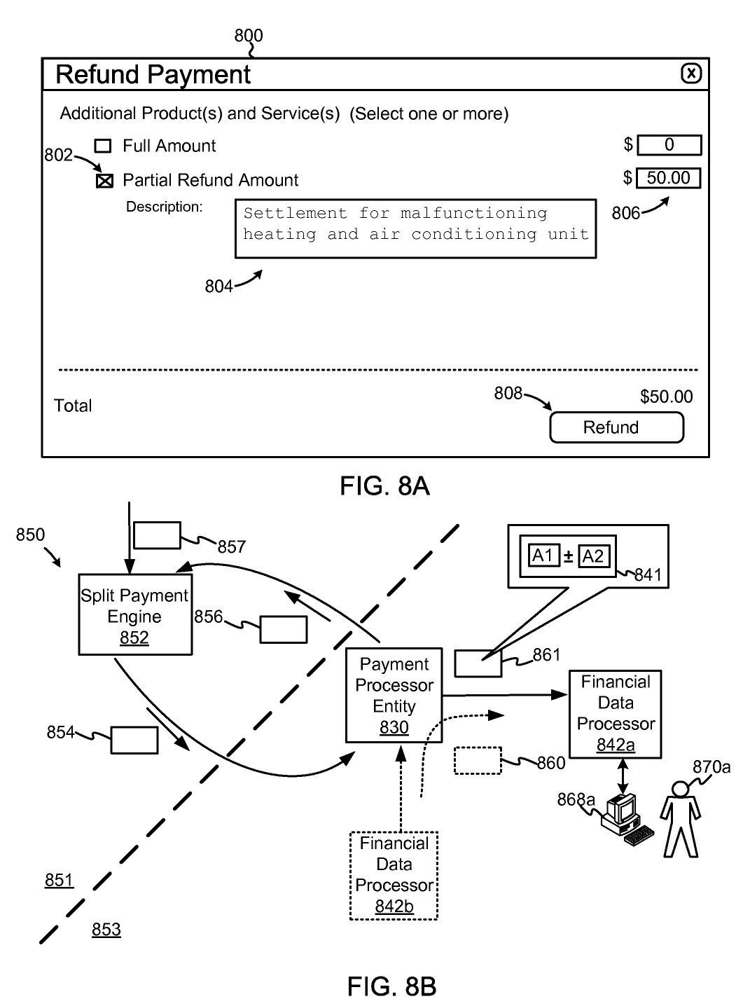

FIGS. 8A and 8B depict a user interface and functional diagram, respectively, of reverse payment request (e.g., a refund request) for multiple goods and services providers, according to some embodiments. FIG. 8A depicts a user interface 800, for example, generated by a provider aggregator system (or a reservation manager) for presentation on a display of a purchaser computing device. User interface 800 is depicting fields in which a purchaser (or traveler) or an owner can generate a request a reverse payment or a refund. As shown, an input field 802 is selected for selecting a partial refund amount set forth as amount 806 for the reasons describe in field 804. In this case, either the traveler is requesting, or the home owner is generating, a refund request to settle the problem of a malfunctioning heating and air conditioning unit. The refund request is generated upon selection of input (“refund”) 808. As shown in diagram 850 of FIG. 8B, a refund request 854 is generated by a split payment engine 852 responsive to a request 857 originating in a non-party region 851. Split payment request 854 is received by payment processor entity 830, which resides in a party region 853. In some instances, an account associated with 842b can provide a source of a refund amount 860 that is deposited into the purchaser's account, which resides in a financial data processor 842a associated with purchaser 870a. The purchaser's account is accessible via computing device 868a by purchaser 870a. In other instances, the refund amount can be aggregated or combined with another financial transaction, such as a payment request. For example, consider that a last installment of the rental payment for a rental property is requested in transaction “A1.” Typically, a payment transaction A1 requires a fee. Further, a refund request for a refund amount is depicted as transaction “A2,” which also requires a fee. To optimize the payment processing between payment processor entity 830 and financial data processor 842a, an amount associated with transaction A1 is combined with the amount associated with transaction A2. Therefore, an aggregate transaction 841 as transaction 861 accomplishes both transactions A1 and A2, but is associated with one fee. Aggregate transaction 841 thereby reduces costs on behalf of payment processor entity 830. Payment processor entity 830 generates a message 856 specifying that the multiple electronic transactions have been completed for the payees, whereby the aggregated electronic transaction is charged, for example, to the purchaser's credit card account.

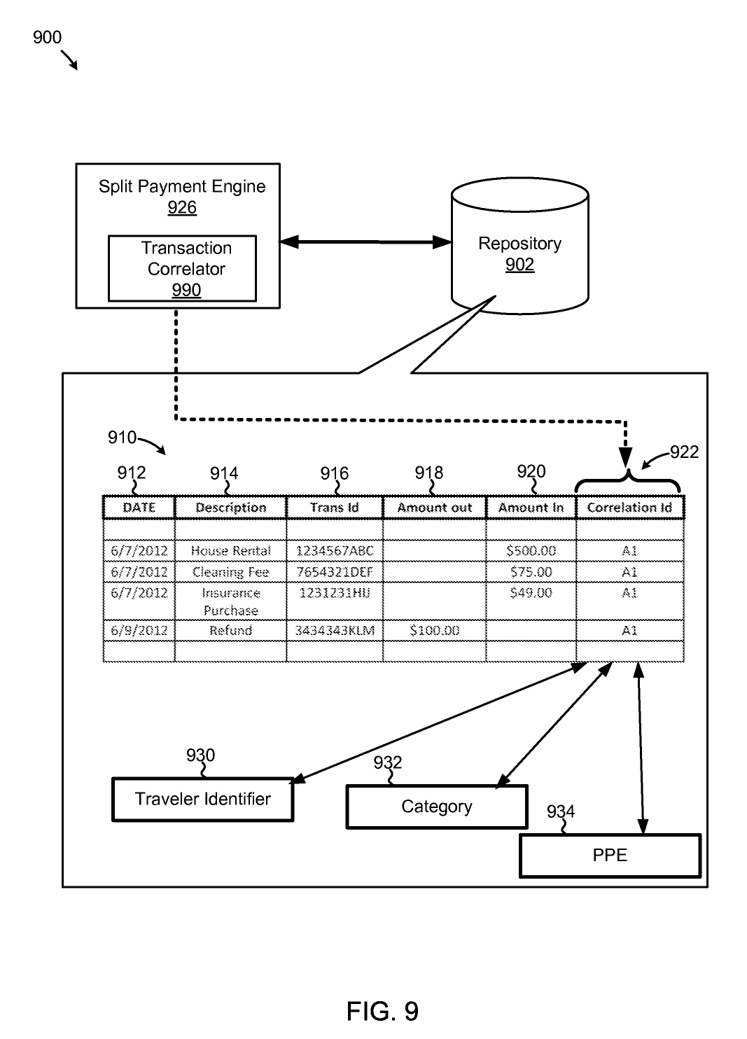

FIG. 9 is a diagram depicting a transaction correlator, according to some embodiments. Diagram 900 depicts a split payment engine 926 including a transaction correlator 990 coupled to a repository storing a data arrangement 910 (as a data structure) to correlate transactions. Optionally, transaction correlator 990 can be implemented separate from the structures and/or functions of split payment engine 926. As shown, data arrangement 910 includes data representing a date 912, a description 914, a transaction identifier (“trans id”) 916, an amount going out 918, an amount coming in 920, and a correlation identifier (“Id”) 922 for each row representing a transaction. More or fewer columns can be implemented, according to some embodiments. For example, another column may be added (not shown) to include an “original transaction ID” for a purchase that can be linked to, for example, a transaction ID 916 associated with a refund. Thus, a refund (or any other transaction) can be linked to another transaction by way of the original transaction ID and/or a correlation ID 922

Transaction correlator 990 is configured to assign a correlation identifier 922 to a subset of transactions associated with an order, including payment transactions, refund transactions, void transactions, cancellation transactions, and the like. Further, transaction correlator 990 is configured to assign a correlation identifier 912 with which a provider aggregator system (or a reservation manager) can use to track the evolution of an order during which financial activity can include additional payments, refunds, cancellations, voided transaction, and other independent transactions. In some embodiments, a correlation identifier 922 can be associated with a payment processor entity (“PPE”) 934, a category 932 (e.g., a description of the goods or services), and a traveler identifier 930. In view of these associations, the purchasing behavior of a traveler (or buyer) can be archived and analyzed to improve individualized offerings of goods and services to a purchaser. Correlation identifiers 922 can be used to determine how payments were split into different transactions, and for identifying from the independent transactions which items that were rented, bought, sold, returned, etc. In the context of renting property, correlation identifiers 922 can be used to identify ancillary goods and services and certain characteristics thereof (e.g., amount, quantities, types, conditions, timing, etc.) that are subject to a split payment operation so that historical trends and behavior of travelers can be analyzed for the benefit of the consumer. Correlation identifiers 922 can be used to prevent paying back too much money (i.e., an “over refund”) over a number of different transactions (e.g., atomic transactions) to a purchaser.

As shown, each transaction (e.g., independent financial transaction) in the subset of transactions for an order is represented by correction identifier “A1.” By implementing correlation identifiers 922, split payment engine 926 or a payment processor entity, or both, can operate to optimize an electronic transaction. As discussed above, multiple transactions can be aggregated into one transaction. In some cases, certain types of transactions have different fee structures and amounts. As such, a financial transaction, such as a refund request, can be substituted by a void transaction, which may cost less than request a refund while accomplishing the intended goal (e.g., return funds to the purchaser). Therefore, transactions can be optimized to, among other things, reduce costs for a payment processor.

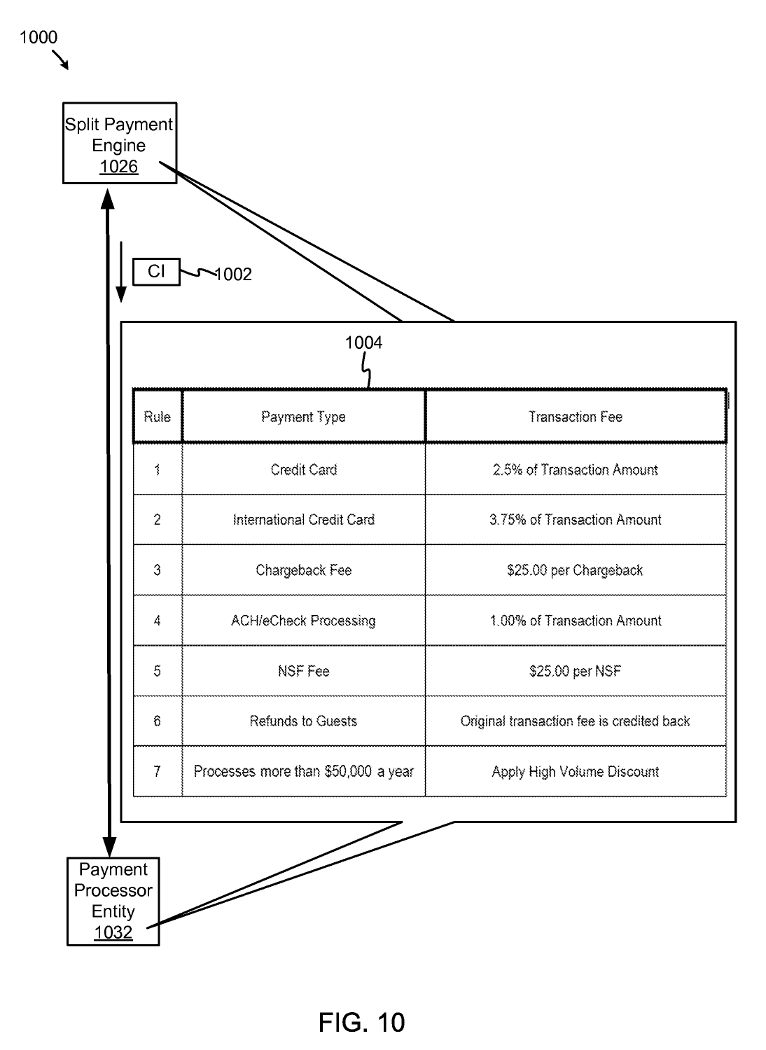

FIG. 10 is a diagram depicting a payment processor entity receiving a correlation identifier in view of a transaction fee structure, according to some embodiments. Diagram 1000 depicts a split payment engine 1026 configured to transmit a correlation identifier (“CI”) 1002 to a payment processor entity 1032 in view of a data structure 1004 including a transaction fee structure, which can be accessed by either split payment engine 1026 or payment processor entity 1032, or both. Payment processor entity 1032 can use correlation identifier 1002 to optimize or otherwise reduce the amount of transaction fees for various financial transactions made in association with correlation identifier 1002. By determining amounts to either charge or refund for a purchaser, payment processor entity 1032 can aggregate electronic transactions to form an aggregated electronic transaction. The aggregated electronic transaction is then transmitted to a recipient financial data processor, such as an online bank. Further, payment transactions may be made via electronic check transactions rather than credit card transactions, if both are available, to reduce costs.

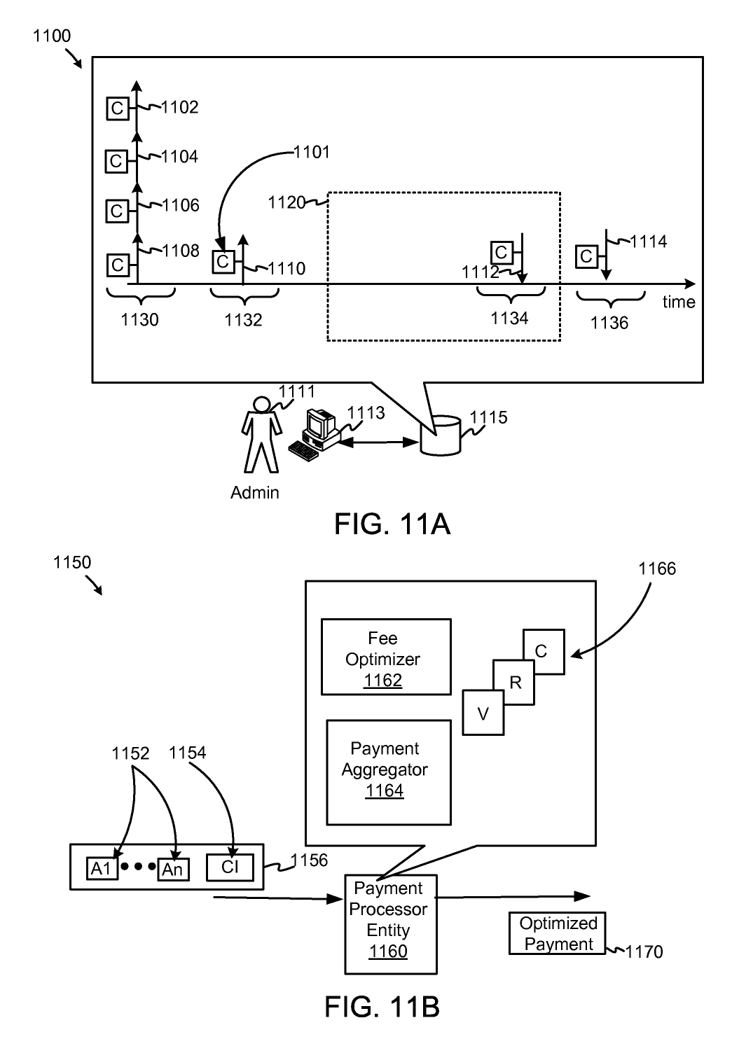

FIGS. 11A and 11B are diagrams depicting use of a correlation identifier, according to some embodiments. Diagram 110 of FIG. 11A includes a repository 1115 including a data arrangement configured to store data associated with a correlation identifier (“C”) 1101, which is linked to multiple transactions of an order. Repository 1115 is assessable via computing device 1113 by an administrator (“admin”) 1111 of a provider aggregator system (or a reservation manager). The transactions can include as a number of financial transactions arising from a traveler's purchases related to renting a house and ancillary goods and services. Consider that a traveler has paid at time point 1130 for a rental home reserved (for duration 1120) with payment 1102. At the same time, the traveler also paid for a cleaning service with payment 1104, an insurance product payment 1106, and state taxes with payment 1108. Each payment 1102, 1104, 1106, and 1108 is linked with correlation identifier 1101. Next, consider that the purchaser reserves a jet ski at time point 1132 as an additional payment request through the web site maintained by the provider aggregator system. Payment 1110 for the jet ski also is linked with correlation identifier 1101. Further, consider that the traveler is owed a refund 1112, which arises at time point 1134 during the rental period 1120. At time point 1136, after the traveler has vacated the rental property, the traveler is owed a refund 1114 as a returned damage deposit. As the financial transactions, including refund requests 1112 and 1114, are linked with correlation identifier 1101, various embodiments provide for optimizing transactions to, for example, reduce fees. For example, amounts for refund 1112 and refund 1114 can be aggregated into a single aggregated financial transaction, thereby foregoing expenditure of a fee.

FIG. 11B includes a diagram 1150 depicts a payment processor entity 1160 including a fee optimizer 1162, a payment aggregator 1164, and a number of calculators 1166, including a voiding calculator (“V”), a refund calculator (“R”) and a cancellation calculator (“C”), among other various calculators (not shown). Such calculators can include processors (or at least a portion of logic) and executable instructions for identifying whether to implement a voiding operation, a refund operation or a cancellation operation in view of reducing costs, for example. An example of a cancellation calculator (“C”) can be configured to provide a partial return of money rather than a total amount (e.g., a cancellation policy may specify that less than the full purchase amount may be returned if, for example, a purchases fails to request a refund 10 days before the service/rental is to be used). Consider that an aggregated electronic transaction 1156 includes amounts 1152 for a subset of financial transactions and at least one correlation identifier (“CI”) 1154 associated with the subset of financial transactions. Fee optimizer 1162 is configured to optimize transactions in a variety of ways, such as by, for example, reducing fee amounts expended. Fee optimizer 1162 is configured to determine that void transactions have smaller fee amounts than refund transactions, which, in turn, have smaller fee amounts than cancellation transactions. For a specific transaction, voiding calculator (“V”), refund calculator (“R”) and cancellation calculator (“C”) can determine the respective fees for performing a void transaction, a refund transaction and a cancellation transaction. Then, fee optimizer 1162 can select the type of transaction (e.g., void) that provides a reduced fee amount, if that type of transaction is suitable to accomplish the function(s) of the pre-optimized transaction. In addition, payment aggregator 1164 can be configured to aggregate or collapse financial transactions into fewer transactions to further reduce fee costs. To illustrate, consider that a traveler is owed five (5) refunds from two (2) service providers. Rather than issuing refunds, fee optimizer can select “void” operations as the associated fees are less costly than “refund” operations. Next, payment aggregator 1164 is configured to aggregate three (3) transactions into one (1) transaction for a first service provider, and to aggregate two (2) transactions into one (1) transaction for a second service provider. Thus, optimized payment 1170 can be generated by reducing the number of transaction fees and/or modifying the type of transaction, based on correlation identifier 1154.

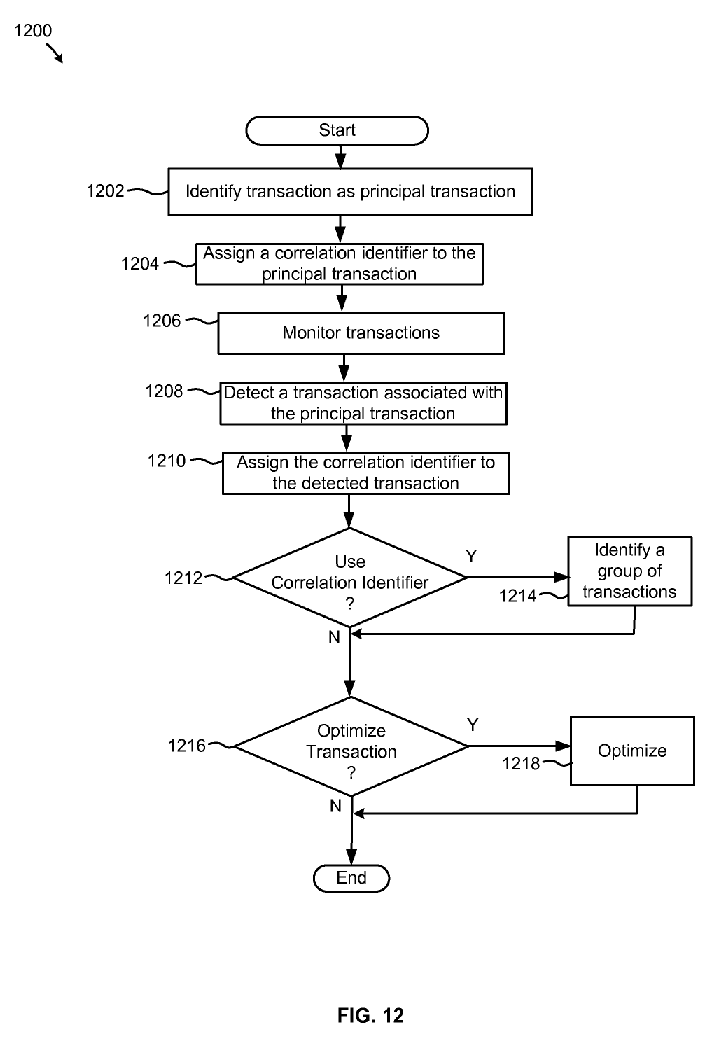

FIG. 12 is an example of a flow 1200 of optimizing transactions based on correlation identifiers, according to some embodiments. Flow 1200 begins by identifying a transaction as a principal transaction at 1202. For example, a request and/or a payment for a reservation for a rental property can be identified to be a principal transaction. At 1204, a correlation identifier is assigned and linked to the principal transaction. Other transactions are monitored at 1206. A transaction associated with the principal transaction, such as an ancillary transaction, is detected at 1208. At 1210, the correlation identifier is assigned (e.g., linked) to the detected transaction. At 1212, a determination is made as to whether use the correlation identifier, such as in generating a report or performing an analysis (or in making a payment/reverse payment). If so, a group of transactions are identified using the correlation identifier at 1214. Otherwise, flow 1200 moves to 1216 at which a determination is made as to whether a transaction is to be optimized. If so, flow 1200 moves to 1218 to optimize a transaction as described herein. Otherwise, flow 1200 terminates.

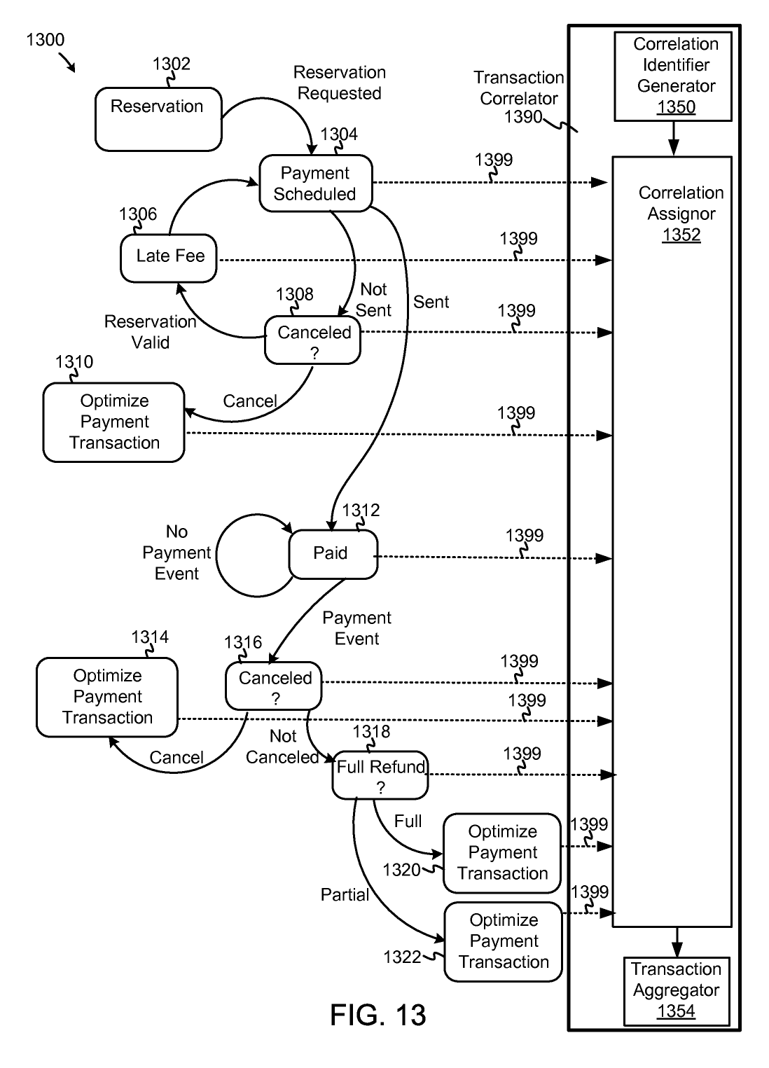

FIG. 13 is a functional state diagram depicting states in which a provider aggregator system or a reservation manager correlates transactions, according to various embodiments. Diagram 1300 depicts a correlation identifier generator 1350, a correlation assignor 1352, and a transaction aggregator 1354, all of which can be constituents of a transaction correlator 1390, which is discussed above and herein. As shown, functional state diagram 1300 includes a reservation state 1302 during which a reservation is made, and a payment scheduled state 1304 during which a payment is scheduled, but payment is yet to be completed. If a payment is not sent, the system determines whether the reservation is canceled at 1308. If so, a payment transaction is optimized (e.g., to return funds to the purchaser) at 1310. But if the reservation remains valid, an optional late fee is assessed at 1306 and the payment scheduled state remains at state 1304. If a payment is sent, the system transitions to a paid state 1312. If no payment event occurs, the system remains in paid state 1312. But if a payment event occurs, the system determines whether a cancellation occurs at 1316. If the reservation is canceled, the payment transaction is optimized, if applicable, at 1314. If the reservation is not canceled after payment, a determination is made as to whether a full refund is required, if applicable, at 1318. If so, the system moves to 1320 to optimize the payment transaction, if applicable, to effectuate a full refund. But if a full refund is not requested, then the system determines a partial refund at 1322, as an optimized transaction, if applicable. Correlation identifiers are assigned by correlation assignor 1352 for one or more transactions 1399 monitored by correlation assignor 1352. Therefore, an order for a rental home and ancillary goods and services can be monitored, and evolution of the order can also be tracked as various additional payments and/or reverse payments 1399 occur in time.

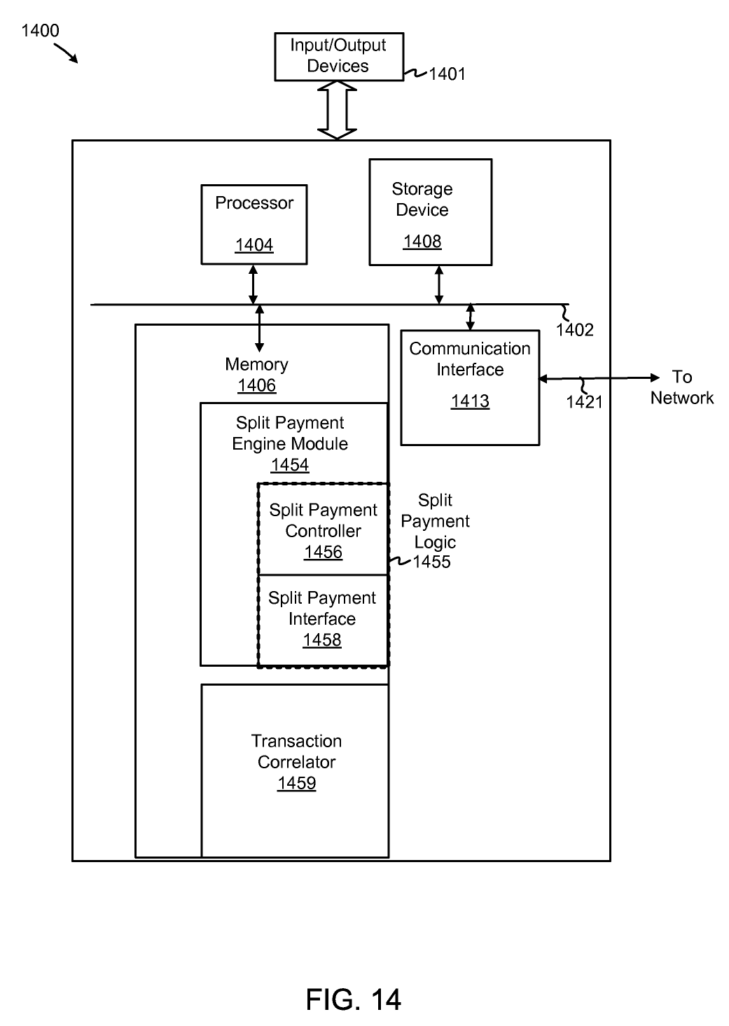

FIG. 14 illustrates an exemplary computing platform in accordance with various embodiments. In some examples, computing platform 1400 may be used to implement computer programs, applications, methods, processes, algorithms, or other software to perform the above-described techniques. Computing platform 1400 includes a bus 1402 or other communication mechanism for communicating information, which interconnects subsystems and devices, such as processor 1404, system memory 1406 (e.g., RAM, etc.), storage device 1408 (e.g., ROM, etc.), a communication interface 1413 (e.g., an Ethernet or wireless controller, a Bluetooth controller, etc.) to facilitate communications via a port on communication link 1421 to communicate, for example, with a computing device. Processor 1404 can be implemented with one or more central processing units (“CPUs”), such as those manufactured by Intel® Corporation, or one or more virtual processors, as well as any combination of CPUs and virtual processors. Computing platform 1400 exchanges data representing inputs and outputs via input-and-output devices 1401, including, but not limited to, keyboards, mice, audio inputs (e.g., speech-to-text devices), user interfaces, displays, monitors, cursors, touch-sensitive displays, and other I/O-related devices.

According to some examples, computing platform 1400 performs specific operations by processor 1404 executing one or more sequences of one or more instructions stored in system memory 1406, and computing platform 1400 can be implemented in a client-server arrangement, peer-to-peer arrangement, or as any mobile computing device, including smart phones and the like. Such instructions or data may be read into system memory 1406 from another computer readable medium, such as storage device 1408. In some examples, hard-wired circuitry may be used in place of or in combination with software instructions for implementation. Instructions may be embedded in software or firmware. The term “computer readable medium” refers to any tangible medium that participates in providing instructions to processor 1404 for execution. Such a medium may take many forms, including but not limited to, non-volatile media and volatile media. Non-volatile media includes, for example, optical or magnetic disks and the like. Volatile media includes dynamic memory, such as system memory 1406.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 1402 for transmitting a computer data signal.

In some examples, execution of the sequences of instructions may be performed by computing platform 1400. According to some examples, computing platform 1400 can be coupled by communication link 1421 (e.g., a wired network, such as LAN, PSTN, or any wireless network) to any other processor to perform the sequence of instructions in coordination with (or asynchronous to) one another. Computing platform 1400 may transmit and receive messages, data, and instructions, including program, i.e., application code, through communication link 1421 and communication interface 1413. Received program code may be executed by processor 1404 as it is received, and/or stored in memory 1406, or other non-volatile storage for later execution.

In the example shown, system memory 1406 can include various modules that include executable instructions to implement functionalities described herein. In the example shown, system memory 1406 includes a split payment engine module 1454 configured to implement split payments in association with an aggregated financial transaction. Split payment engine module 1454 can include a split payment controller module 1456 and a split payment interface module 1458. In some embodiments, split payment logic 1455 can be implemented in memory 1406 as, for example, as or within split payment controller module 1456. According to some embodiments, system memory 1406 can also include a transaction correlator module 1459 configured to provide one or more functions described herein.

In at least some examples, the structures and/or functions of any of the above-described features can be implemented in software, hardware, firmware, circuitry, or a combination thereof. Note that the structures and constituent elements above, as well as their functionality, may be aggregated with one or more other structures or elements. Alternatively, the elements and their functionality may be subdivided into constituent sub-elements, if any. As software, the above-described techniques may be implemented using various types of programming or formatting languages, frameworks, syntax, applications, protocols, objects, or techniques. As hardware and/or firmware, the above-described techniques may be implemented using various types of programming or integrated circuit design languages, including hardware description languages, such as any register transfer language (“RTL”) configured to design field-programmable gate arrays (“FPGAs”), application-specific integrated circuits (“ASICs”), or any other type of integrated circuit. According to some embodiments, the term “module” can refer, for example, to an algorithm or a portion thereof, and/or logic implemented in either hardware circuitry or software, or a combination thereof. These can be varied and are not limited to the examples or descriptions provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

1. A method comprising:
receiving data representing a request via a network implementing one or more communication protocols to acquire multiple goods or services from different good or service providers, each of the multiple goods or services being associated with a cost of acquisition;
identifying an account associated with the request, the account being a resource for financing the cost of acquisition of the multiple goods or services;
implementing dynamic pricing of at least one of the multiple goods or services;
initiating a split payment operation at a processor to apply against the account, the split payment operation comprising:
determining that the split payment operation is associated with either
a first state in which a transaction with each provider of the multiple goods or services is capable of being fulfilled, or
a second state in which at least one transaction with a provider of the multiple goods or services is not capable of being fulfilled; and
causing, if the request is in the first state, payments to each provider of the multiple goods or services from the account, the payments collectively represented as a single transaction in association with the account.

2. The method of claim 1, wherein the payments to each provider of the multiple goods or services from the account are transmitted to accounts associated with corresponding providers of the multiple goods or services.

3. The method of claim 2, further comprising:
receiving data representing authorization to pay all of the providers of the multiple goods or services; and
transmitting the payments in parallel.

4. The method of claim 1, further comprising:
performing the split payment operation including:
generating transaction requests to a subset of providers of the multiple goods or services; and
identifying that the subset of providers of the multiple goods or services are capable of fulfilling a portion of the request.

5. The method of claim 4, wherein the split payment operation is in the first state.

6. The method of claim 4, further comprising:
detecting that a transaction with the provider of the multiple goods or services is not capable of fulfilling another portion of the request.

7. The method of claim 6, wherein the split payment operation transitions from the first state to the second state, the transaction being a failed transaction.

8. The method of claim 6, further comprising:
rolling back the transaction requests to ensure that none of the providers of the multiple goods or services are configured to provide the multiple goods or services in the request, thereby facilitating a fail-safe manner of acquiring the multiple goods or services from the different good or service providers.

9. The method of claim 8, further comprising:
disassociating the transaction request from a batch process that executes payment via an electronic Automated Clearing House (“ACH”) network.

10. The method of claim 1, wherein the split payment operation is disposed in an application programming interface (“API”).

11. The method of claim 10, wherein the API is disposed at a payment processor entity.

12. The method of claim 11, further comprising:
presenting a web page as an interface, the web page being generated at a merchant entity.

13. The method of claim 12, further comprising:
passing the request via the merchant entity to the payment processor entity; and
initiating the payments from the payment processor entity to accounts associated with providers of the multiple goods or services.

14. The method of claim 1, further comprising:
identifying data representing a request for a reverse payment from a merchant account to the account; and
initiating the split payment operation to include the reverse payment.

15. The method of claim 14, wherein the reverse payment is a full refund or a partial refund.

16. A system comprising:
a provider aggregator including one or more processors and memory configured to facilitate financial transactions between merchant accounts and a payment in response to a request transmitted via a network from a purchaser computing device, the provider aggregator configured to provide a web interface for offering a principal good or service and ancillary good and services associated with the principal good or service, at least one of the principal good or service and the ancillary good and services being associated with a dynamically-determined price; and
a split payment engine configured to aggregate the financial transactions as a single transaction, and configured to initiate fulfillment of the financial transactions in which goods or services are exchanged for the financial transactions if the principal good or service and the ancillary good and services are capable of being fulfilled, the split payment engine being further configured to roll-back the request and each of the financial transactions if the principal good or service and the ancillary good and services are not capable of being fulfilled,
wherein the payment processor initiates electronic payments for the principal good or service and the ancillary good and services.

17. The system of claim 16, wherein the principal good or service comprises real property rental services and the ancillary good and services comprises rental insurance services.

18. The system of claim 16, further comprising:
a third party provider controller configured to offer third party goods or services via the web interface, the split payment engine being configured to facilitate payment to a third party provider of other goods and services from the payment processor.

19. The system of claim 16, wherein the split payment engine is an application programming interface (“API”).

20. The system of claim 16, wherein the payment processor is an entity configured to provide electronic payments as a service (“ePaaS”) via the network.
